(19) United States
(12) Patent Application Publication
(10) Pub. No.: US 2007/0176420 A1
(43) Pub. Date: Aug. 2, 2007

(54) CONNECTOR-AND-TUBE ASSEMBLY AND METHOD FOR FORMING THE SAME

(75) Inventors: Kazuyuki Saito, Shiojiri-shi (JP); Yoshiki Nakamura, Higashichikuma-gun (JP)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/670,029

(22) Filed: Feb. 1, 2007

(30) Foreign Application Priority Data
Feb. 1, 2006 (JP) 2006-025074
Aug. 21, 2006 (JP) 2006-224161

(51) Int. Cl. F16L 13/00

(52) U.S. Cl. 285/285.1

(57) ABSTRACT

A connector-and-tube assembly includes a tube composed of a material having elasticity; at least one cylindrical member whose opposite ends communicate with each other and which is composed of a material having a higher coefficient of elasticity than that of the tube; and a connector having a communication hole through which the tube communicates with the outside, the connector being integrated with an end of the tube. The at least one cylindrical member is fitted within the tube at least at the end of the tube.

### BACKGROUND

1. Technical Field

The present invention relates to a connector-and-tube assembly and to a method for forming the same. In particular, the invention relates to a connector-and-tube assembly having a connector composed of resin that is attached to an end of a tube composed of thermoplastic resin, and to a method for forming the same.

2. Related Art

Elastic tubes composed of an elastic material, such as resin, rubber, and elastomer, are easily bendable and do not break as a result of deformation caused by vibration or bending. For this reason, elastic tubes are used in a variety of fields related to fluids, such as gas and liquid. Generally, as discussed in JP-A-2000-168099, when connecting an elastic tube of this type to a component composed of a rigid material, the connection is achieved by utilizing the elasticity of the elastic tube. However, the connecting process in this connecting technique is troublesome and is thus not preferable for industrial purposes.

JP-A-11-157092 discloses a technique in which a connector is integrated with an end of an elastic tube so that the elastic tube can be readily connected to other components. For example, this technique involves forming the connector by injection molding using an appropriate rigid material and then combining the connector with the end of the elastic tube by outsert molding. This allows the elastic tube to be readily connected to or disconnected from other components as well as achieving a secure connection.

On the other hand, with regard to the structure of the elastic tube, JP-A-2003-320680 discloses an elastic tube that has a multi-tube structure having a plurality of independent tube portions arranged parallel to each other. The multi-tube structure can be bent readily in a direction crosswise to a plane on which the tube portions are arranged and can allow different kinds of fluids to flow individually through the tube portions. Accordingly, in color printers, for example, different color inks and coating agents can individually be transported simultaneously in a collective fashion.

However, if the molding process is implemented by injecting materials having different physical properties into a single mold, problems may occur at a point after the molding process when the fluidity of the materials is lost. In detail, since pressure is applied during the molding process, a relatively soft material may become deformed when the mold is released after the molding process, resulting in a molded product having a specification different from the desired one. For example, if a flexible tube and a rigid connector are to be formed by integral molding, a linking pin, for example, will be inserted into the tube. Because a linking pin is composed of a material with low deformability, such as metal, the pressure received during the molding process is absorbed by the deformation of the tube. However, when the linking pin is pulled out of the tube after the molding process, the tube becomes deformed towards its inner surface, which is a free surface. This causes the internal diameter of the tube to decrease, resulting in a less flow volume of liquid.

On the other hand, if the molding process is implemented in a state where the mold partially extends into the resin, which is to become the molded product, there may be cases where the melted resin injected in the mold becomes fixedly attached to the mold during the molding process. The molded product obtained as a result of such a molding process is problematic in that, when the mold is being released or when the part of the mold extending into the product is being pulled out, the mold may undesirably be pulled out together with segments of the molded product, resulting in burrs. These burrs are known as “melted burrs” which undesirably reduce the effective internal diameter of the connector and interfere with the insertion of other components.

When integrally forming a rigid-plastic connector and a component having a plurality of liquid supply channels as discussed in JP-A-2000-168099, the pressure applied to the injected material is absorbed by the deformation of the flexible liquid supply tube. For this reason, there may be a case where a sufficient adhesive strength cannot be attained between the connector and the tube. In addition, due to temperature fluctuation and pressure fluctuation occurring during the molding process, a detachment may occur in the interface between the liquid supply tube and the connector, resulting in leakages of liquid between the liquid supply channels.

### SUMMARY

According to a first aspect of the present invention, a connector-and-tube assembly is provided, which includes a tube composed of a material having elasticity; at least one cylindrical member whose opposite ends communicate with each other and which is composed of a material having a higher coefficient of elasticity than that of the tube; and a connector having a communication hole through which the tube communicates with the outside, the connector being integrated with an end of the tube. The at least one cylindrical member is fitted within the tube at least at the end of the tube. Accordingly, the at least one cylindrical member with low deformability support the tube having high elastic deformability from the inside of the tube at the end thereof, thereby preventing the tube from being deformed within the connector disposed at the end of the tube. Furthermore, since the tube is prevented from deformation, if the connector is to be formed by injecting a different material around the end of the tube, the internal diameter of the tube is prevented from being reduced as a result of deformation of the tube or the adhesive strength between the tube and the material is prevented from deteriorating. Accordingly, a connector-and-tube assembly with the desired design intent can be provided. In addition, liquid flowability can be achieved without having to remove the at least one cylindrical member after the molding process, whereby the product can be manufactured at low cost without having to increase the number of manufacturing steps.

Furthermore, in the connector-and-tube assembly according to the first aspect, it is preferable that the tube have a multi-tube structure having a combination of a plurality of independent tube portions arranged parallel to each other on a single plane. In this case, the at least one cylindrical member preferably includes a plurality of cylindrical members that are fitted to the corresponding independent tube portions. Accordingly, even if the connector is integrated with the multi-tube structure, leakages of liquid between the tube portions are prevented, whereby a component that can handle different kinds of liquids simultaneously in a collective fashion can be manufactured at low cost.

Furthermore, in the connector-and-tube assembly according to the first aspect, it is preferable that the at least one cylindrical member fitted to the tube extend into the tube in the longitudinal direction of the tube. Accordingly, this ensures proper communication between the tube and the at least one cylindrical member, whereby liquid flowability can be achieved without having to remove the at least one cylindrical member after the molding process.

Furthermore, in the connector-and-tube assembly according to the first aspect, it is preferable that the at least one cylindrical member fitted to the tube extend out of the tube in the longitudinal direction of the tube. Accordingly, this ensures proper communication between the component disposed at the end of the tube and the at least one cylindrical member, thereby achieving liquid flowability. In addition, this also contributes to a higher adhesive strength between the tube and the molded product.

Furthermore, in the connector-and-tube assembly according to the first aspect, it is preferable that the at least one cylindrical member be given a length such that the at least one cylindrical member does not extend to an end of the communication hole that is opposite to an end thereof proximate to the tube. Accordingly, since the at least one cylindrical member is implanted within the connector, the molded connector can be treated in the same manner as if it does not contain the at least one cylindrical member.

Furthermore, in the connector-and-tube assembly according to the first aspect, it is preferable that the at least one cylindrical member extend to an end of the communication hole that is opposite to an end thereof proximate to the tube. Accordingly, the opening at the end of the liquid flow channel within the connector can be reinforced, thereby allowing for higher durability and a larger number of times the insertion and extraction can be performed. In addition, since the liquid flow channel within the connector is defined by the at least one cylindrical member, a connector having a complex flow channel configuration can be readily manufactured by using a cylindrical member of a desired shape. Furthermore, since it is not necessary to form the liquid flow channel with a mold, the cost required for molds can be reduced.

Furthermore, in the connector-and-tube assembly according to the first aspect, it is preferable that the at least one cylindrical member protrude from an end of the communication hole that is opposite to an end thereof proximate to the tube such as to extend to the outside of the connector. Accordingly, the at least one cylindrical member itself can be used as a part of the connector. In addition, by fitting an O-ring around the cylindrical member, for example, a connector of a new structure can be provided.

Furthermore, in the connector-and-tube assembly according to the first aspect, it is preferable that the at least one cylindrical member be composed of metal. Accordingly, a cylindrical member that is less deformable against, for example, pressure or heat applied during a molding process can be provided, whereby the tube included in the connector-and-tube assembly can be prevented from being deformed.

Furthermore, in the connector-and-tube assembly according to the first aspect, it is preferable that the at least one cylindrical member be composed of a thermosetting resin. Accordingly, a cylindrical member that is cheaper than that of metal and that can fit well in the tube and the connector can be provided, whereby a low-cost connector-and-tube assembly can be provided.

Furthermore, in the connector-and-tube assembly according to the first aspect, it is preferable that the at least one cylindrical member be composed of a thermoplastic resin having a softening temperature that is higher than a molding temperature of the tube and a molding temperature of the connector. Accordingly, a cylindrical member having a desired shape and desired dimensions can be provided at low cost.

According to a second aspect of the present invention, a method for forming a connector on an end of a tube composed of a material having elasticity is provided, the connector having a communication hole through which the tube communicates with the outside. The method includes inserting a cylindrical member into the tube so that the cylindrical member is engaged with at least an end of the tube, the cylindrical member having opposite ends that communicate with each other and being composed of a material having a higher coefficient of elasticity than that of the tube; and encompassing the end of the tube engaged to the cylindrical member with a mold and forming the connector by molding. Accordingly, the cylindrical member prevents the tube from becoming deformed from the inside of the tube at the end thereof, whereby deformation of the tube is prevented from occurring when forming the connector by injecting a different material around the end of the tube. This prevents the internal diameter of the tube from being reduced as a result of deformation of the tube or prevents the adhesive strength between the tube and the material from deteriorating. In addition, because the cylindrical member does not melt during the molding process, the aforementioned melted burrs are prevented from forming inside the molded body when the mold is released. Furthermore, since liquid flowability can be achieved without having to remove the cylindrical member after the molding process, the manufacturing process can be simplified, whereby the product can be manufactured at low cost.

Furthermore, the method according to the second aspect may further include setting the cylindrical member inside the mold; attaching the tube onto the cylindrical member set inside the mold; and inserting a material for forming the connector into the mold that contains therein the cylindrical member and the tube. In this case, the setting, attaching, and inserting steps are performed in the above order. Accordingly, this facilitates the process for attaching the cylindrical member to the tube. Moreover, since the end of the tube can be positioned within the mold by means of the cylindrical member, the connector can be formed with high accuracy.

Furthermore, in the method according to the second aspect, it is preferable that the cylindrical member have an internal diameter that is equal to or smaller than an internal diameter of the tube. Accordingly, if the two internal diameters are equal to each other, the internal flow channel in the connector-and-tube assembly is given a substantially uniform internal diameter except for where the tube and the connector overlap with each other, thereby achieving a high flow efficiency of fluid. On the other hand, if the internal diameter of the cylindrical member is smaller, an insertion length for inserting a projection provided in the mold into the cylindrical member can be determined, thereby contributing to improved workability.

Furthermore, in the method according to the second aspect, it is preferable that the cylindrical member be tapered such that an external diameter thereof decreases with increasing distance from the end of the tube. Accordingly, the tube can be fitted readily onto the cylindrical member, thereby contributing to improved productivity of the connector-and-tube assembly.

Furthermore, in the method according to the second aspect, it is preferable that the cylindrical member have a step portion at a position that corresponds to the end of the tube when the cylindrical member and the tube are engaged with each other, such that the step portion abuts against the end of the tube when the cylindrical member and the tube are in the engaged state. Accordingly, the engagement depth of the tube with respect to the cylindrical member can be made uniform, whereby the final product of the connector-and-tube assembly can be made with stable quality.

Furthermore, in the method according to the second aspect, it is preferable that the end of the tube that engages with the cylindrical member have a surface that is slanted with respect to the longitudinal direction of the tube. Accordingly, the tube having elasticity can be readily fitted onto the cylindrical member, thereby contributing to improved productivity of the connector-and-tube assembly.

The summary described above does not include all of the required features of the invention. In addition, sub-combinations of these features are also permissible in the invention.

### BRIEF DESCRIPTION OF THE DRAWINGS

The present invention will be described with reference to the accompanying drawings, wherein like numbers reference like elements.

FIG. 1 is a perspective view of an ink jet recording apparatus 1 equipped with an elastic tube 14.

FIG. 2 is an enlarged partial view of the elastic tube 14 equipped with a connector 15, which are included in the ink jet recording apparatus 1.

FIG. 3 illustrates the connector 15 shown in FIG. 2, as viewed from a direction different from that in FIG. 2.

FIG. 4 is a cross-sectional view of the connector 15 shown in FIGS. 2 and 3.

FIG. 5 is a cross-sectional view of the elastic tube 14.

FIG. 6 illustrates a mold 400 used for forming the connector 15.

FIG. 7 is a cross-sectional view of a joint 510 according to a second embodiment of the invention.

FIG. 8 is a cross-sectional view of a joint 520 according to a third embodiment of the invention.

FIG. 9 illustrates a section where a metallic cylindrical member 300 extends into an elastic tube 14 within a connector 530 according to a fourth embodiment of the invention.

FIG. 10 illustrates a section where a metallic cylindrical member 300 extends into an elastic tube 14 within a connector 540 according to a fifth embodiment of the invention.

FIG. 11 illustrates a section where a metallic cylindrical member 300 extends into an elastic tube 14 within a connector 550 according to a sixth embodiment of the invention.

FIG. 12 illustrates a section where a metallic cylindrical member 300 extends into an elastic tube 14 within a connector 560 according to a seventh embodiment of the invention.

### DESCRIPTION OF EXEMPLARY EMBODIMENTS

Exemplary embodiments of the present invention will be described below with reference to the drawings. However, it is to be understood that the invention is not limited to the embodiments described below, and not all of the combinations of features described in the following embodiments are essential for carrying out the invention.

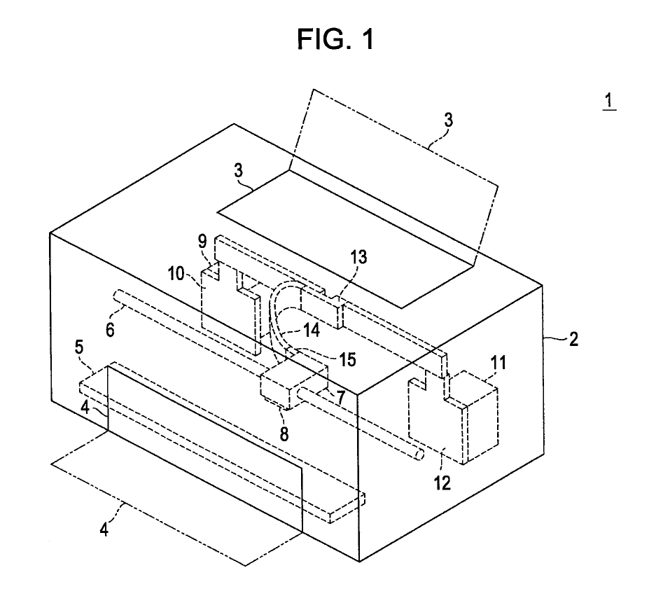

FIG. 1 schematically illustrates an overall structure of an ink jet recording apparatus 1 which is equipped with an elastic tube 14 integrated with a connector 15. As shown in the drawing, the ink jet recording apparatus 1 has a feed tray 3 through which a recording sheet is fed into the apparatus 1 and a catch tray 4 to which a recorded sheet is ejected. The feed tray 3 is disposed at the rear upper portion of a housing 2 of the apparatus 1 while the catch tray 4 is disposed on the front face of the housing 2. A recording sheet fed into the housing 2 through the feed tray 3 passes above a platen 5 disposed within the housing 2 and is ejected to the catch tray 4. Although not shown in the drawing, the housing 2 contains therein a feeding device for feeding recording sheets stacked on the feed tray 3 in a one-by-one fashion into the housing 2, a transporting device for transporting each of the fed recording sheets onto the platen 5, and an ejecting device for ejecting the sheet passed above the platen 5 onto the catch tray 4.

Inside the housing 2, a guide member 6 is disposed parallel to the platen 5 at a position above the platen 5. The guide member 6 has a carriage 7 mounted thereto, which can reciprocate in a direction parallel to the platen 5 by being guided by the guide member 6. The carriage 7 has a recording head 8 disposed on a lower surface thereof, which discharges ink towards a recording sheet placed above the platen 5. Although not shown in the drawing, the housing 2 also contains a driver that drives the carriage 7 in a reciprocating fashion.

Furthermore, the housing 2 also contains a pair of ink cartridges 9, 11 which hold inks to be discharged from the recording head 8. The inks held in the ink cartridges 9, 11 travel sequentially through ink channels 10, 12, a connector 13, the elastic tube 14, and the connector 15 so as to be supplied to the recording head 8 of the carriage 7. The ink cartridges 9, 11, the ink channels 10, 12, and the connector 13 are stationary with respect to the housing 2. On the other hand, the connector 15 is connected to the carriage 7, which means that the elastic tube 14 that connects the connector 13 to the connector 15 is repetitively bent and stretched in response to the reciprocation of the carriage 7.

The connector 13 and the connector 15 are integrated with the elastic tube 14, thereby constituting a connector-and-tube assembly. Consequently, when assembling the ink jet recording apparatus 1, the carriage 7 and the ink channels 10, 12 are individually assembled first, and the connector 15 and the connector 13 disposed at opposite ends of the elastic tube 14 are then respectively combined with the carriage 7 and the pair of ink channels 10, 12.

The ink jet recording apparatus 1 having the above-described structure allows for a high-speed operation since the reciprocable carriage 7 has a lightweight design. In addition, the ink cartridges 9, 11 can be given a large size, whereby the ink jet recording apparatus 1 is suitable for conditions where the ink consumption is large.

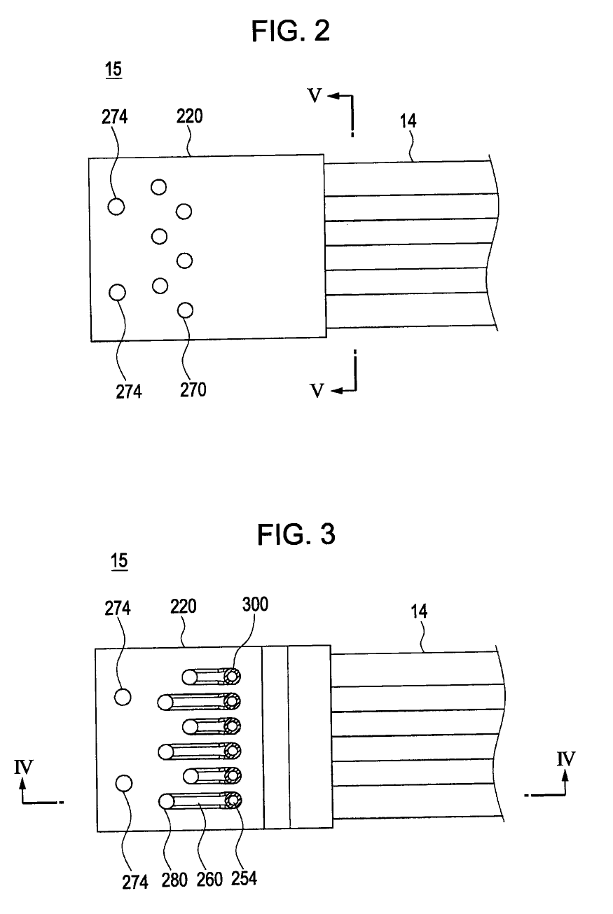

FIG. 2 illustrates the connector 15, which is integrated with one end of the elastic tube 14 so as to connect the elastic tube 14 to the carriage 7, in the ink jet recording apparatus 1 shown in FIG. 1, as viewed from a side proximate to the carriage 7. As shown in the drawing, the connector 15 is constituted by a molded body 220 having the one end of the elastic tube 14 implanted therein. The molded body 220 has a plurality of communication ports 270 that individually communicate with flow channels 141 of the elastic tube 14, and positioning holes 274 used for the positioning of the connector 15 when the connector 15 is mounted to the carriage 7.

FIG. 3 illustrates the connector 15 shown in FIG. 2, as viewed from a side opposite to that in FIG. 2. As illustrated in the drawing, the communication ports 270 shown in FIG. 2 extend through the molded body 220 to the rear surface thereof so as to form communication holes 280 in the rear surface. The communication holes 280 communicate with first ends of corresponding metallic cylindrical members 300 via communication grooves 260. The positioning holes 274 similarly extend through the molded body 220 to the rear surface thereof, but instead of communicating with other components, the positioning holes 274 end at the rear surface.

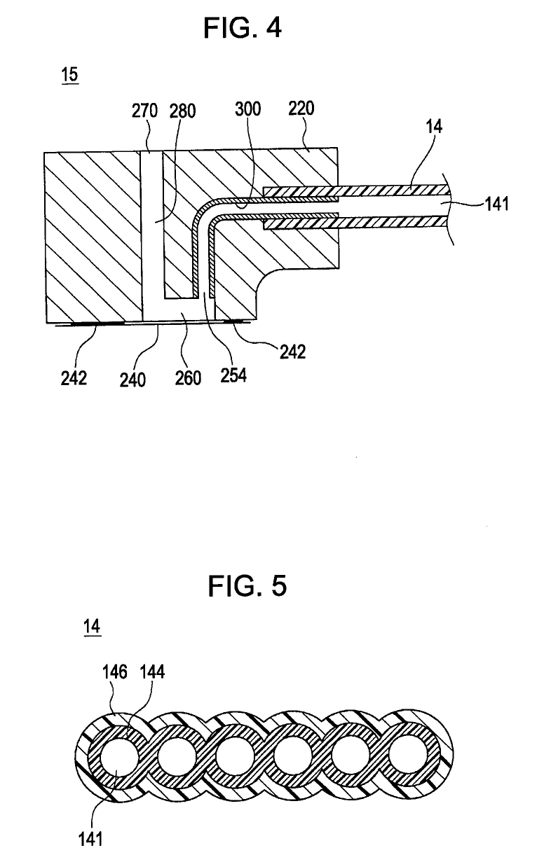

FIG. 4 is a cross-sectional view of the connector 15 taken along line IV-IV in FIG. 3. As shown in the drawing, each communication hole 280 extends through the molded body 220 from the corresponding communication port 270 so as to communicate with an opening 254 located at the first end of the corresponding metallic cylindrical member 300 via the corresponding communication groove 260. The elastic tube 14 extends into the molded body 220 from one side surface thereof, and the metallic cylindrical member 300 forms a curve inside the molded body 220 so that the second end of the metallic cylindrical member 300 extends into the elastic tube 14 until the second end is flush with the side surface of the molded body 220.

Although not shown in FIG. 3, the communication grooves 260 are sealed with a film 240 which is hermetically adhered to adhesive sections 242 of the molded body 220. Thus, the flow channels 141 in the elastic tube 14 can communicate with the communication ports 270 via the communication grooves 260 and the communication holes 280. Although stainless-steel tubes are used as the metallic cylindrical members 300 in the first embodiment, cylindrical members of other materials may be used alternatively as long as they have enough strength for maintaining their shape against pressure applied during the molding process of the connector 15.

FIG. 5 is a cross-sectional view of the elastic tube 14 taken along line V-V in FIG. 2. As shown in the drawing, the elastic tube 14 has a multi-tube structure having the plurality of flow channels 141. The flow channels 141 are arranged in isolation from each other on a single plane and can individually allow fluids to flow therethrough. The connector 15 has the communication structure shown in FIG. 4 for each of these flow channels 141. Accordingly, the plurality of communication ports 270 in the molded body 220 can communicate individually with the corresponding flow channels 141.

Furthermore, the elastic tube 14 has a two-layer structure which includes an inner hollow layer 144 that forms the flow channels 141 and an outer layer 146 that encompasses the inner layer 144. In this case, the material used for the outer layer 146 is contained in the material used for forming the inner layer 144 and the molded body 220 and has a melting point that is preferably equal to or lower than the melting point of the inner layer 144. For example, if the molded body 220 contains polypropylene (PP) resin, a PP resin is similarly used for the outer layer 146. When forming the outer layer 146 using such a material, a polyolefin resin is used as an adhesive material. Consequently, when forming the molded body 220 by outsert molding, a high adhesive strength can be attained between the molded body 220 and the outer layer 146. Such an elastic tube 14 can be formed independently by extrusion molding.

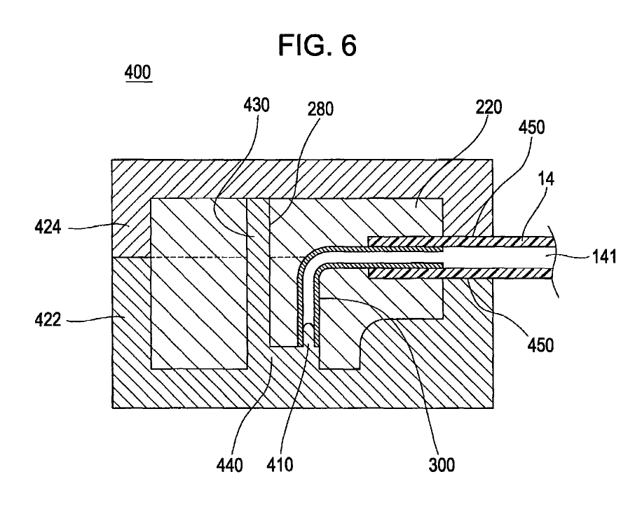

FIG. 6 illustrates the structure of a mold 400 used when forming the connector 15 shown in FIGS. 2 to 4, and also illustrates a method for forming the molded body 220 by using the mold 400. The mold 400 is shown in cross section, which is viewed in the same manner as the cross section in FIG. 4.

As shown in FIG. 6, the mold 400 is a combination of an upper mold component 424 and a lower mold component 422. The mold 400 has an internal cavity with a shape that corresponds to the outer shape of the molded body 220 of the connector 15. Inside the mold 400, large projections 430 that correspond to the shape of the communication holes 280 project upward from the bottom surface of the lower mold component 422 to the upper mold component 424. In addition, the mold 400 includes bulges 440 that correspond to the communication grooves 260 in the molded body 220, and small projections 410 having an external diameter that corresponds to the internal diameter of the metallic cylindrical members 300. Moreover, the mold 400 has a cutout 450 on one side surface thereof, which has a shape that corresponds to the outer shape of the elastic tube 14.

The method for forming the molded body 220 using the mold 400 includes the following steps. First, the elastic tube 14 formed by, for example, extrusion molding and the metallic cylindrical members 300 formed into desired dimensions are prepared. Then, the first ends of the metallic cylindrical members 300 are fitted onto the small projections 410 of the lower mold component 422, and the second ends of the metallic cylindrical members 300 are inserted into one end of the elastic tube 14. In this case, the elastic tube 14 is positioned on the cutout 450 of the lower mold component 422.

In the above step, the metallic cylindrical members 300 and the elastic tube 14 may be engaged to each other either before or after the metallic cylindrical members 300 are fitted onto the small projections 410. This sequence may be determined in view of the shapes of the mold 400, the metallic cylindrical members 300, and the like.

In the state where the metallic cylindrical members 300 and the elastic tube 14 are mounted on the lower mold component 422, the upper mold component 424 is placed on the lower mold component 422. Then, the material for forming the molded body 220, in a melted state, is inserted into the cavity of the mold 400 through an inlet (not shown). After the cavity in the mold 400 is filled with the material, the material is cooled down. Subsequently, the mold 400 is removed, and as a result, the connector 15 shown in FIGS. 2 to 4 is formed on the one end of the elastic tube 14.

In the above-described forming method, the connector 15 is formed in a state where the metallic cylindrical members 300 with low deformability is fitted to the elastic tube 14. Thus, the elastic tube 14 is prevented from being deformed within the molded body 220, whereby a desired flow volume can be maintained in the elastic tube 14. In addition, since the metallic cylindrical members 300 can be left within the molded body 220, a step for removing flow-channel forming components, such as pins, can be omitted. Moreover, the metallic cylindrical members 300 extending into the molded body 220 can prevent fluid leakages that can cause an interface detachment between the elastic tube 14 and the molded body 220. Furthermore, the metallic cylindrical members 300 can serve as flow channels within the molded body 220, thereby eliminating the need for preparing a mold with a complex shape for forming a complex flow-channel configuration while still having the capability to readily form a complex three-dimensional flow-channel configuration.

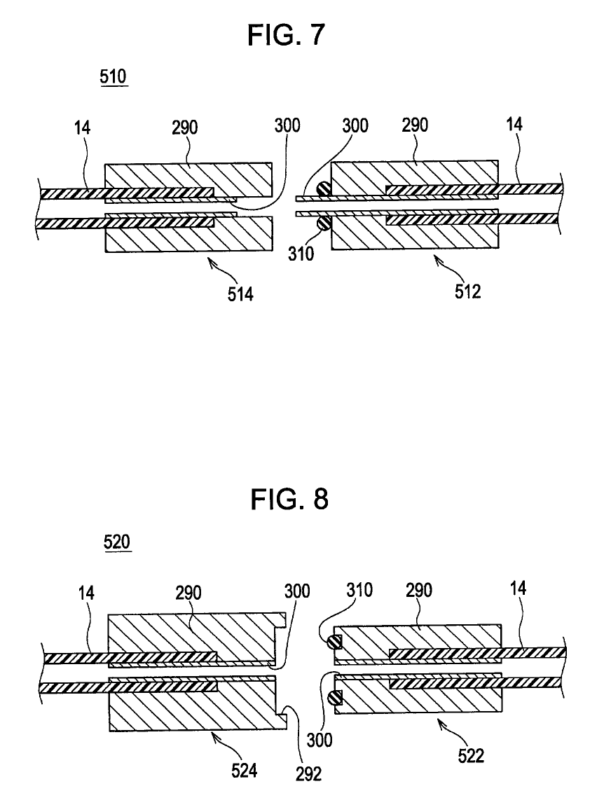

FIG. 7 is a cross-sectional view of a joint 510 according to a second embodiment of the invention, which includes a male connector 512 and a female connector 514 that can be manufactured by the above-described forming method. As shown in the drawing, the male connector 512, which is shown at the right side of the drawing, and the female connector 514, which is shown at the left side of the drawing, form a pair so as to constitute the joint 510 between elastic tubes 14.

The male connector 512 has a first elastic tube 14 whose one end extends into a molded body 290 through one side surface thereof, and metallic cylindrical members 300 whose first ends extend into the first elastic tube 14. The second ends of the metallic cylindrical members 300 extend outward from the other side surface of the molded body 290. Each of the metallic cylindrical members 300 extending outward from the molded body 290 has an O-ring 310 fitted thereto.

On the other hand, the female connector 514 is similar to the male connector 512 in that it has a second elastic tube 14 whose one end extends into a molded body 290 through one side surface thereof, and metallic cylindrical members 300 whose first ends extend into the second elastic tube 14. However, the second ends of the metallic cylindrical members 300 in the female connector 514 are disposed within the molded body 290 and do not extend to the other side surface of the molded body 290.

The joint 510, which is a combination of the male connector 512 and the female connector 514, can be used to connect the first and second elastic tubes 14 shown at the right and left sides of the drawing by inserting the second ends of the metallic cylindrical members 300 of the male connector 512 into the female connector 514. In a state where the male connector 512 and the female connector 514 are connected to each other, the O-rings 310 interposed between the two molded bodies 290 seal the space therebetween in a liquid-tight or airtight manner so as to prevent fluid flowing through this connected section from leaking.

Although not shown in the drawing, the molded bodies 290 may be provided with, for example, latches that engage with each other when the male connector 512 and the female connector 514 are connected to each other so that the connected state between the two connectors 512 and 514 can be maintained. Although the male and female components to be connected to each other are defined by connectors in FIG. 7, one of the connectors may be replaced by, for example, the ink cartridge 9 or 11 or the carriage 7 included in the ink jet recording apparatus 1 shown in FIG. 1.

FIG. 8 is a cross-sectional view of a joint 520 according to a third embodiment of the invention, which can be manufactured by the above-described forming method. As shown in the drawing, the joint 520 similarly includes a male connector 522, which is shown at the right side of the drawing, and a female connector 524, which is shown at the left side of the drawing. The male connector 522 and the female connector 524 form a pair so as to constitute the joint 520 between elastic tubes 14.

The male connector 522 has a first elastic tube 14 whose one end extends into a molded body 290 through one side surface thereof, and metallic cylindrical members 300 whose first ends extend into the first elastic tube 14. The second ends of the metallic cylindrical members 300 are flush with the other side surface of the molded body 290. Furthermore, the other side surface of the molded body 290 has grooves which surround the corresponding metallic cylindrical members 300 and have O-rings 310 fitted therein.

On the other hand, the female connector 524 is similar to the male connector 522 in that it has a second elastic tube 14 whose one end extends into a molded body 290 through one side surface thereof, and metallic cylindrical members 300 whose first ends extend into the second elastic tube 14, and that the second ends of the metallic cylindrical members 300 are flush with the other side surface of the molded body 290. However, the female connector 524 is different from the male connector 522 in that the other side surface of the molded body 290 has a step portion 292 having a shape that corresponds to the other side surface of the male connector 522.

By allowing the male connector 522 and the female connector 524 to abut against each other, the joint 520 can allow the first and second elastic tubes 14 shown at the right and left sides of the drawing to communicate with each other. In a state where the male connector 522 and the female connector 524 are connected to each other, the O-rings 310 interposed between the two molded bodies 290 seal the space therebetween in a liquid-tight or airtight manner so as to prevent fluid flowing through this connected section from leaking.

Although not shown in the drawing, the molded bodies 290 may be provided with, for example, latches that engage with each other when the male connector 522 and the female connector 524 are connected to each other so that the connected state between the two connectors 522 and 524 can be maintained. Although the male and female components to be connected to each other are defined by connectors in FIG. 8, one of the connectors may be replaced by, for example, the ink cartridge 9 or 11 or the carriage 7 included in the ink jet recording apparatus 1 shown in FIG. 1.

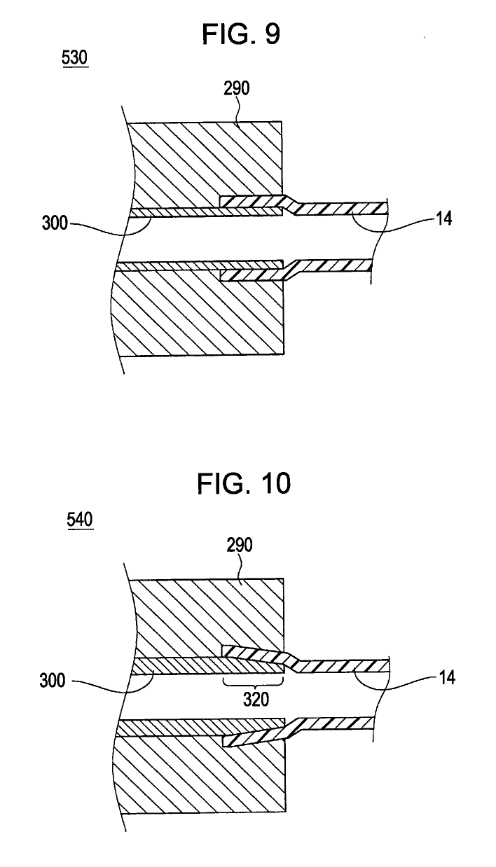

FIG. 9 is an enlarged view of a section where a metallic cylindrical member 300 extends into an elastic tube 14 within a connector 530 according to a fourth embodiment of the invention. As shown in the drawing, the internal diameter of the elastic tube 14 and the internal diameter of the metallic cylindrical member 300 can be made substantially the same by utilizing the elastic deformability of the elastic tube 14. Thus, the internal flow channels in the connector 530 are given a substantially uniform internal diameter, thereby achieving a high flow efficiency of fluid and a large effective flow volume.

FIG. 10 is an enlarged view of a section where a metallic cylindrical member 300 extends into an elastic tube 14 within a connector 540 according to a fifth embodiment of the invention. As shown in the drawing, in this connector 540, the metallic cylindrical member 300 has a tapered portion 320 provided at least in the vicinity of an end of the metallic cylindrical member 300, such that the metallic cylindrical member 300 tapers toward its end. Thus, the end of the metallic cylindrical member 300 can be easily fitted into the elastic tube 14, thereby contributing to higher productivity. On the other hand, because the end of the elastic tube 14 engages with a section of the metallic cylindrical member 300 where the diameter thereof is large, the elastic tube 14 and the metallic cylindrical member 300 can be attached firmly to each other.

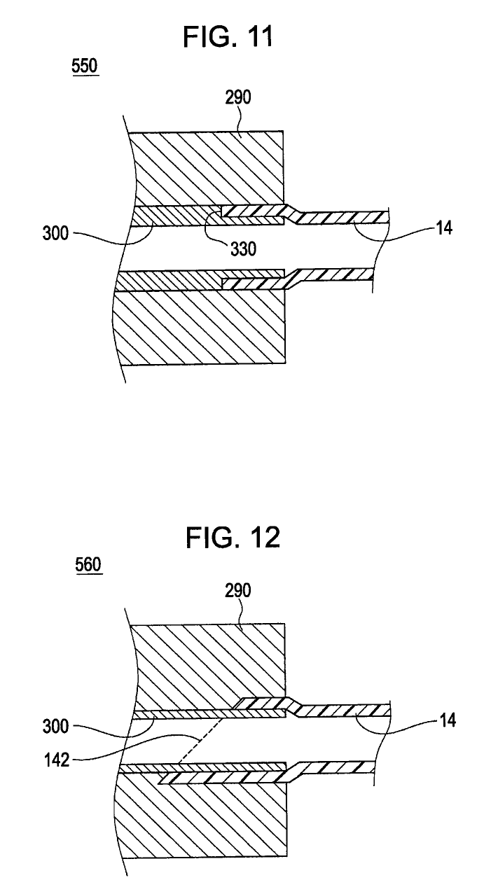

FIG. 11 is an enlarged view of a section where a metallic cylindrical member 300 extends into an elastic tube 14 within a connector 550 according to a sixth embodiment of the invention. As shown in the drawing, in this connector 550, the metallic cylindrical member 300 has a step portion 330 disposed at a position that corresponds to the engagement end of the elastic tube 14, such that the step portion 330 abuts against this end of the elastic tube 14 when the metallic cylindrical member 300 and the elastic tube 14 are in the engaged state. Consequently, the engagement depth of the elastic tube 14 with respect to the metallic cylindrical member 300 is made uniform, whereby the final product of the connector 550 can be made with stable quality.

FIG. 12 is an enlarged view of a section where a metallic cylindrical member 300 extends into an elastic tube 14 within a connector 560 according to a seventh embodiment of the invention. As shown in the drawing, in this connector 560, an end surface 142 of the elastic tube 14, which is an end that engages with the metallic cylindrical member 300, is slanted with respect to the longitudinal direction of the elastic tube 14. This contributes to higher workability for the engagement between the elastic tube 14 and the metallic cylindrical member 300, thereby achieving higher productivity of the connector 560.

For the purpose of simplifying the above description, the molded bodies 220, 290 to be combined with the elastic tube 14 by outsert molding in the above embodiments have been simply referred to as connectors. However, the molded bodies 220, 290 may additionally be provided with, for example, screw holes for mounting purposes, specific shapes for positioning purposes, and brackets for mounting other components such as sensors.

Furthermore, although the above embodiments have been described with reference to an ink supply tube in an ink jet recording apparatus 1, the connector-and-tube assembly can be used for other purposes related to fluids. Specifically, the above embodiments can be applied to, but are not limited to, for example, color-filter manufacturing devices for manufacturing color filters in liquid crystal displays, organic EL displays, electrode forming devices for forming electrodes in FEDs (surface emitting displays), and biochip manufacturing devices for manufacturing biochips.

Although the present invention has been described with reference to the above embodiments, the technical scope of the invention is not limited to the above embodiments. It is to be understood by those skilled in the art that various alterations and modifications are possible in the above embodiments. In addition, it is apparent from the following claims that the scope of the invention encompasses such alternations and modifications.

What is claimed is:

1. A connector-and-tube assembly comprising:
a tube composed of a material having elasticity;
at least one cylindrical member whose opposite ends communicate with each other and which is composed of a material having a higher coefficient of elasticity than that of the tube; and
a connector having a communication hole through which the tube communicates with the outside, the connector being integrated with an end of the tube,
wherein the at least one cylindrical member is fitted within the tube at least at the end of the tube.

2. The connector-and-tube assembly according to claim 1, wherein the tube has a multi-tube structure having a combination of a plurality of independent tube portions arranged parallel to each other on a single plane, and wherein the at least one cylindrical member includes a plurality of cylindrical members that are fitted to the corresponding independent tube portions.

3. The connector-and-tube assembly according to claim 1, wherein the at least one cylindrical member fitted to the tube extends into the tube in the longitudinal direction of the tube.

4. The connector-and-tube assembly according to claim 1, wherein the at least one cylindrical member fitted to the tube extends out of the tube in the longitudinal direction of the tube.

5. The connector-and-tube assembly according to claim 1, wherein the at least one cylindrical member is given a length such that the at least one cylindrical member does not extend to an end of the communication hole that is opposite to an end thereof proximate to the tube.

6. The connector-and-tube assembly according to claim 1, wherein the at least one cylindrical member extends to an end of the communication hole that is opposite to an end thereof proximate to the tube.

7. The connector-and-tube assembly according to claim 1, wherein the at least one cylindrical member protrudes from an end of the communication hole that is opposite to an end thereof proximate to the tube such as to extend to the outside of the connector.

8. The connector-and-tube assembly according to claim 1, wherein the at least one cylindrical member is composed of metal.

9. The connector-and-tube assembly according to claim 1, wherein the at least one cylindrical member is composed of a thermosetting resin.

10. The connector-and-tube assembly according to claim 1, wherein the at least one cylindrical member is composed of a thermoplastic resin having a softening temperature that is higher than a molding temperature of the tube and a molding temperature of the connector.

11. A method for forming a connector on an end of a tube composed of a material having elasticity, the connector having a communication hole through which the tube communicates with the outside, the method comprising:
inserting a cylindrical member into the tube so that the cylindrical member is engaged with at least an end of the tube, the cylindrical member having opposite ends that communicate with each other and being composed of a material having a higher coefficient of elasticity than that of the tube; and
encompassing the end of the tube engaged to the cylindrical member with a mold and forming the connector by molding.

12. The method according to claim 11, further comprising:
setting the cylindrical member inside the mold;
attaching the tube onto the cylindrical member set inside the mold; and
inserting a material for forming the connector into the mold that contains therein the cylindrical member and the tube,
wherein the setting, attaching, and inserting steps are performed in the above order.

13. The method according to claim 11, wherein the cylindrical member has an internal diameter that is equal to or smaller than an internal diameter of the tube.

14. The method according to claim 11, wherein the cylindrical member is tapered such that an external diameter thereof decreases with increasing distance from the end of the tube.

15. The method according to claim 11, wherein the cylindrical member has a step portion at a position that corresponds to the end of the tube when the cylindrical member and the tube are engaged with each other, such that the step portion abuts against the end of the tube when the cylindrical member and the tube are in the engaged state.

16. The method according to claim 11, wherein the end of the tube that engages with the cylindrical member has a surface that is slanted with respect to the longitudinal direction of the tube.
